(19) United States
(12) Patent Application Publication
(10) Pub. No.: US 2007/0216982 A1
(43) Pub. Date: Sep. 20, 2007

(54) TWO DIMENSIONAL MICRO SCANNER

(75) Inventors: Renatus Hendricus Maria Sanders, Eindhoven (NL); Willem Hoving, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,570

(22) PCT Filed: Sep. 22, 2005
(86) PCT No.: PCT/IB05/53127

§ 371 Date: Mar. 20, 2007

(30) Foreign Application Priority Data
Sep. 28, 2004 (EP) 04104704.4

(51) Int. Cl. G02B 26/10

(52) U.S. Cl. 359/201; 359/226

(57) ABSTRACT

A two dimensional scanner comprising a first mirror (1) rotatable around a first axis (4), and a second mirror (2) rotatable around a second axis (5), said first and second reflective surfaces being formed on the same substrate (3), with their axis of rotation (4, 5) being non parallel in a common plane, and a reflective surface (6) arranged such that a light beam reflected by said first mirror (1) is subsequently reflected by said surface (6) and finally by said second mirror (2). According to the invention, the first mirror is thus capable of scanning said light beam in a first direction and said second mirror is capable of scanning said light beam in a second direction. The result is a very compact two dimensional scanner, where the two individual mirrors are independent of each other, but still can be provided very close together, eliminating, or at least reducing distortion of the image.

The present invention relates to a two dimensional scanner comprising at least two one dimensional scanners in the form of a mirror rotatable around an axis.

In conventional two dimensional scanners used for laser projection systems, a small, high frequency MEMS (micro-electrical mechanical system) mirror is often combined with a slower and larger conventional mirror. Typically, the high frequency is in the order of kHz, while the low frequency is in the order of Hz. However, such systems are too large to comply with the size reduction required in most commercial products.

Therefore, it is desirable to replace the conventional mirror with a second MEMS scanner (or any other scanner of equivalent size). However, it is extremely difficult to align two separate scanners of such small size as MEMS scanners, making such a solution very difficult to realize.

One solution is a 2D MEMS scanner where a smaller scanner is formed on the surface of a larger torsion scanner. The reflective surface of the smaller scanner can thus perform a 2D scanning. An example of a 2D scanner by combining two torsion scanners is shown in U.S. Pat. No. 5,629,790. A problem with such 2D scanners is that the characteristics of both mirrors are intimately related to each other. In other words, the dimensions and frequencies cannot be chosen independently from each other. That is the reason that there are no currently available 2D MEMS mirrors available that meet the required combination of frequencies (order of 10 kHz/100 Hz) having a required size (order of mm).

Therefore, it would be desirable to use two independent 1D scanners. However, as the packaging of a MEMS scanner is typically quite bulky, the two scanners will be located at a relatively large distance from each other. This distance will give rise to distortion of the image if it is not compensated for. An example of such distortion compensation, including a complicated system of curved mirrors is shown in the US application 2004/0027641.

It is an object of the present invention to overcome this problem, and to provide a 2D scanner suitable for use in a miniature laser projection system.

This and other objects are achieved with a scanner of the kind mentioned by way of introduction, wherein the two mirrors are formed on the same substrate with their axis of rotation being non parallel in a common plane, and wherein a reflective surface is arranged such that a light beam reflected by the first mirror is subsequently reflected by the reflective surface and finally by the second mirror.

According to the invention, the first mirror is thus capable of scanning said light beam in a first direction and said second mirror is capable of scanning said light beam in a second direction. The result is a very compact two dimensional scanner, where the two individual mirrors are independent of each other, but still can be provided very close together, eliminating, or at least reducing distortion of the image.

The reflective surface is preferably fixed in relation to the first and second axis. This results in a simple and robust design, where a given angle of incidence into the scanner always results in the same output, for a given position of the two rotatable mirrors. According to a preferred embodiment, the reflective surface is parallel with the common plane of the first and second mirrors.

The first and second axis can be perpendicular to each other, resulting in a simple 2D scanning, where the first mirror scans in the x direction, while the second mirror scans in the y direction.

The first and second mirrors can advantageously be formed by MEMS mirrors, which readily can be manufactured with suitable characteristics. By providing two MEMS on the same substrate, a 2D scanner according to the invention can be realized.

For example, the first and second mirrors can each be formed on the rotatable parts of two separate MEMS torsion scanners formed in the substrate. Such torsion scanners are known in the art, and it is considered possible to manufacture several such scanners in the same substrate. The substrate can be of silicon.

The first rotatable mirror can adapted to oscillate with a first resonance frequency and the second rotatable mirror adapted to oscillate with a second resonance frequency, wherein the first frequency is different from the second frequency. This is useful when the scanner is used in a display device, where the low frequency can correspond to the sweep (once per frame), while the high frequency corresponds to the line scan (once for every line in every frame). As mentioned, the lower frequency is typically in the order of Hz, while the high frequency is in the order of kHz.

This and other aspects of the present invention will now be described in more detail, with reference to the appended drawings showing a currently preferred embodiment of the invention.

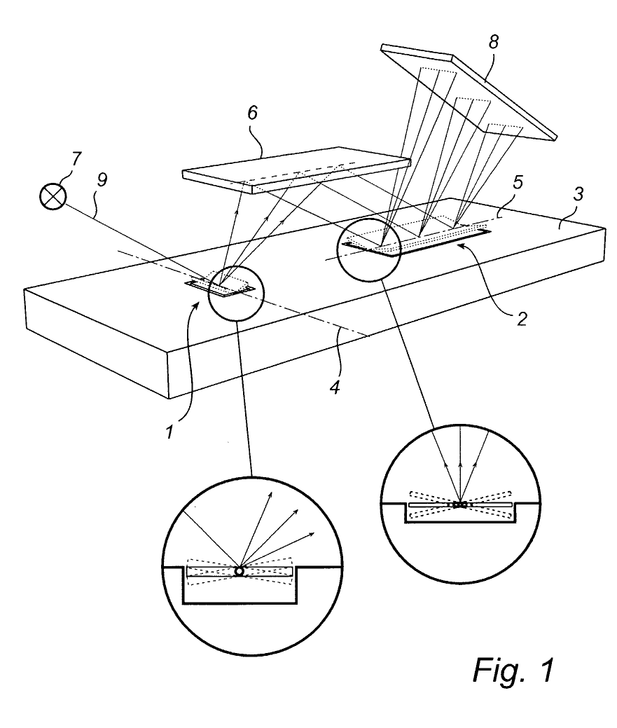

FIG. 1 is a perspective view of a first embodiment of a projection system including a scanner according the invention.

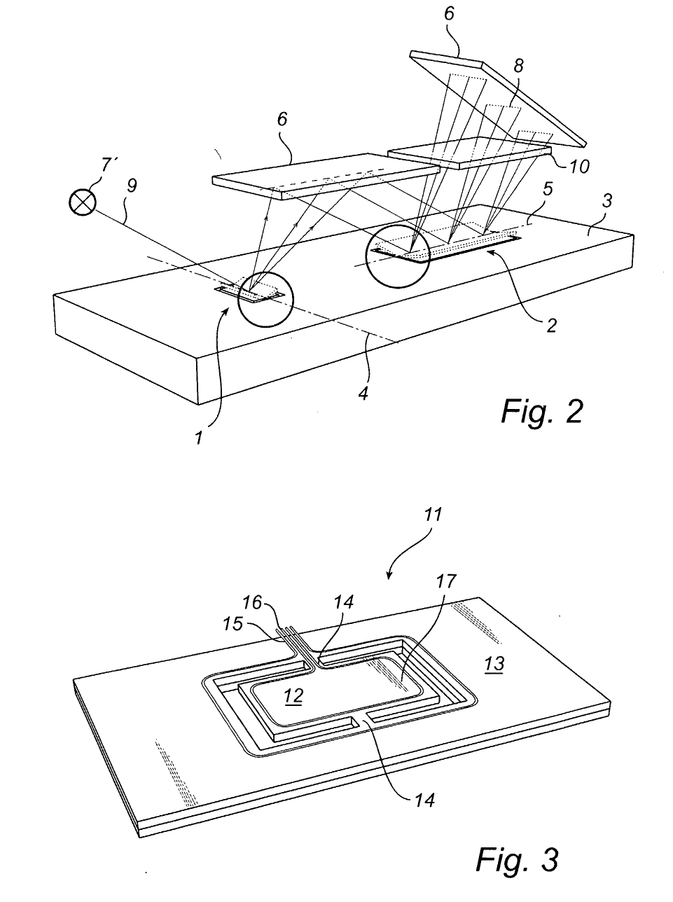

FIG. 2 is a perspective view of a second embodiment of a projection system including a scanner according the invention.

FIG. 3 is a perspective view of a rotatable mirror suitable for the scanner in FIG. 1.

The scanner in FIG. 1 comprises two rotatable mirrors 1 and 2 formed on a common substrate 3, e.g. a silicon substrate. Each mirror is rotatable around an axis 4, 5, which here are essentially perpendicular to each other.

Another reflective surface 6 is provided at a distance from the two one dimensional scanners 1 and 2. In the illustrated example, the surface 6 is flat, and fixed in relation to the scanners 1, 2, and also essentially parallel with the plane of the axis 4, 5. This is not necessary, and a number of alternative ways to arrange the reflective surface 6 are possible.

Apart from the scanner comprising the mirrors 1, 2 and the reflective surface 6, FIG. 1 also shows a modulated light source 7 and a screen 8. A light beam 9 from the light source 7 is directed onto the first scanner 1, and scanned in a direction perpendicular to the axis 4. The scanned beam is then reflected by the reflecting surface 6, to be directed onto the second scanner 2 and scanned in a second direction, perpendicular to the second axis 5. As a result, the single beam 9 is scanned over a two dimensional area.

In FIG. 1, the light source is modulated using image data (amplitude and/or color modulation), so that the desired image is generated when the beam is scanned across the screen 8. The screen can be a screen to be watched by a user, either a reflective screen or a transmissive, or it may be preceded by a suitable projection system (not shown).

Alternatively, as shown in FIG. 2, the light source is an unmodulated light source 7′, and a spatial light modulator 10 is arranged to transform the scanned light beam into an image. For example, the modulator can be an array of light valves, such as a liquid crystal light valve. The modulated light is then projected onto the screen 10, again possibly by means of a projection system.

Each mirror 1, 2 can be a micro scanner (also referred to as a MEMS scanner) of a kind known per se, such as a torsion scanner as illustrated in FIG. 2. The torsion scanner 11 comprises a plate-shaped area 12 suspended from the surrounding base 13 by two torsion bars 14 or springs. The plate can be formed by etching of a layer 18, deposited on another layer 19 where a recess has been formed. An actuator 15, 16 is arranged to cause the plate 12 to oscillate at resonance frequency. The actuator is here electrostatic, with two windings 15, 16 providing a voltage difference between the plate 12 and the base 13. Alternatively, it can be a bimorph actuator, or a piezoelectric actuator. By actuating the plate using suitable actuator, the plate 12 can be brought to pivot around the axis defined by the bars 14. The plate is further provided with a reflective surface 17, making the pivoting plate 12 act as a one dimensional scanner.

Two MEMS torsion scanners of this type can be formed on the same substrate. This should be possible using essentially conventional manufacturing processes. If required, the actuators of each scanner can be isolated from each other, in order to avoid cross-talk. As the scanners 1, 2 are formed independently of each other on the substrate 3, they can be designed to have different properties, such as different resonance frequencies. One mirror 1, 2 can therefore have a higher resonance frequency, in the order of kHz, while the other mirror 1, 2 has a lower resonance frequency, in the order of Hz.

The person skilled in the art realizes that the present invention by no means is limited to the preferred embodiments described above. On the contrary, many modifications and variations are possible within the scope of the appended claims. For example, the axis of the two mirrors 1, 2 do not need to be perpendicular. As long as they are not parallel, a 2D scanner can be realized by appropriate control of the mirrors. Further, additional mirrors, or other optical elements may be added to the scanner, for example for guiding the beam from the light source 7 to the first mirror 1, or for guiding the scanned beam from scanner 2 onto the screen 8.

The scanner has here been described in relation to a display device. Naturally, many other applications for the scanner as disclosed herein can be envisaged, in the display field as well as in other fields.

1. A two dimensional scanner comprising:
a first mirror (1) rotatable around a first axis (4), and a second mirror (2) rotatable around a second axis (5), said first and second reflective surfaces being formed on the same substrate (3), with their axis of rotation (4, 5) being non parallel in a common plane, and
a reflective surface (6) arranged such that a light beam reflected by said first mirror (1) is subsequently reflected by said surface (6) and finally by said second mirror (2).

2. A two dimensional scanner according to claim 1, wherein said reflective surface (6) is fixed in relation to said first and second axis.

3. A two dimensional scanner according to claim 2, wherein said reflective surface (6) is parallel to said common plane.

4. A two dimensional scanner according to claim 1, wherein said first and second axis (4, 5) are perpendicular to each other.

5. A two dimensional scanner according to claim 1, wherein said first and second mirrors are formed by MEMS scanners.

6. A two dimensional scanner according to claim 5, wherein said first and second mirrors (1, 2) each are formed by the rotatable plates (12) of two separate torsion scanners (11) formed in the substrate (3).

7. A two dimensional scanner according to claim 5, wherein said substrate is of silicon.

8. A two dimensional scanner according to claim 1, wherein said first mirror (1) is adapted to oscillate with a first resonance frequency and said second mirror (2) adapted to oscillate with a second resonance frequency, said first frequency being different than said second frequency.
